(19) United States
(12) Patent Application Publication
(10) Pub. No.: US 2026/0089617 A1
(43) Pub. Date: Mar. 26, 2026

(54) Policy-Defined Connection Management of Opportunistic Network Capacity

(71) Applicant: Google LLC, Mountain View, CA (US)

(72) Inventors: Matthew R. Blumberg, Foster City, CA (US); Shiyuan Wang, Saratoga, CA (US); Liping Liu, Buffalo Grove, IL (US)

(73) Assignee: Google LLC, Mountain View, CA (US)

(21) Appl. No.: 19/112,572

(22) PCT Filed: Sep. 23, 2022
(86) PCT No.: PCT/US2022/076929

§ 371 Date: Mar. 17, 2025

(51) Int. Cl. H04W 48/18; H04W 24/08; H04W 48/16; H04W 84/12

(52) U.S. Cl. CPC H04W 48/18; H04W 24/08; H04W 48/16; H04W 84/12

(57) ABSTRACT

Aspects of policy-defined connection management of opportunistic network capacity are described. In some aspects, a mobile device having a connection manager may be configured to determine, based on a wireless network policy of the mobile device, contextual information for a connection available through an access point (AP) of a wireless local area network (WLAN) associated with a mobile network operator (MNO). The connection manager measures signal-related characteristics of the WLAN connection and determines, based on the contextual information and the characteristics, a first quality metric. The connection manager also measures second signal-related characteristics of a connection available through a base station of a cellular network associated with the MNO and determines, based on the characteristics, a second quality metric. Based on a comparison of the quality metrics, the connection manager connects the mobile device to the WLAN through the AP or the cellular network through the base station.

### BACKGROUND

Mobile network operators (MNOs), such as cellular carriers, strive to provide users of mobile devices with fast, efficient, and reliable wireless network connections. Carriers can provide such connections through a variety of wireless networks and connection points, including cellular network base stations or wireless local area network (WLAN) routers. As mobile data usage trends continue to rise, network operators may attempt to utilize public Wi-Fi to augment their cellular networks. Managing user data access across different types of connections, however, is typically complex and, when executed poorly, results in a poor user experience. For example, most mobile devices always or automatically connect to a Wi-Fi network available through an access point (AP) that is available to the mobile device regardless of performance of the Wi-Fi network. When the available AP is supporting too many devices, under high load, or subject to other restrictions on data speed and throughput, however, connecting the mobile device to the available AP may result in a slower or poor-quality connection that impairs data access of the mobile device and results in a poor user experience.

### SUMMARY

This document describes systems and techniques of policy-defined connection management of opportunistic network capacity. In some aspects, a mobile device having a connection manager may be configured to determine, based on a wireless network policy of the mobile device, contextual information for a connection available through an access point (AP) of a wireless local area network (WLAN) associated with a mobile network operator (MNO). The connection manager may also measure signal-related characteristics of the WLAN connection, which can include real-time measurements related to latency, jitter, or bandwidth of the WLAN connection. The connection manager can determine, based on the contextual information and the signal-related characteristics of the WLAN connection, a first quality metric for the WLAN connection. The connection manager also measures second signal-related characteristics of a connection available through a base station of a cellular network associated with the MNO and determines, based on the characteristics, a second quality metric for the cellular connection. The connection manager may then compare the first and second quality metrics and connect to the WLAN through the AP or the cellular network through the base station in accordance with the wireless network policy. In other words, based on an analysis of the quality of both WLAN and cellular network connections and in compliance with the MNO administrator-defined policy, the connection manager connects the mobile device to the wireless network through which a higher-performance connection is available. The connection manager may improve user experience through providing a higher-quality connection, providing fewer connection interruptions (e.g., by not connecting to the weak connection), and preserving battery life (again, e.g., by not connecting to the weak connection). The connection manager may connect the mobile device to the network of the MNO capable of providing a better connection based on various factors, which may include connection quality, network congestion, device mobility, data throughput, user preferences, cost, and so forth.

Details of one or more aspects of policy-defined connection management of opportunistic network capacity are set forth in the accompanying drawings and the following description. Other features and advantages will be apparent from the drawings, the description, and the claims. This summary is provided to introduce subject matter that is further described in the Detailed Description and Drawings. Accordingly, this summary does not describe essential features, nor does it limit the scope of the claimed subject matter.

### BRIEF DESCRIPTION OF THE DRAWINGS

This specification describes apparatuses and techniques for policy-defined connection management of opportunistic network capacity with reference to the following drawings. The same numbers are used throughout the drawings to reference similar features and components:

FIG. 1 illustrates an example environment in which a mobile device may implement aspects of policy-defined connection management of opportunistic network capacity;

FIG. 2 illustrates an example configuration of the mobile device from FIG. 1 in more detail;

FIG. 3 illustrates an example implementation of a web-based portal for configuring a wireless network policy in accordance with one or more aspects;

FIG. 4 depicts an example method for determining whether to connect to a wireless network in accordance with one or more aspects;

FIG. 5 illustrates an example method for managing a connection to a WLAN through an AP or to a cellular network through a base station;

FIG. 6 illustrates an example method managing a connection between a first network through a first AP or a second network through a second AP;

FIG. 7 illustrates an example method for managing a wireless network connection of a mobile device based on mobility of the mobile device;

FIG. 8 illustrates an example method for altering a connection status to a first AP based on relative quality metrics of a second AP in accordance with one or more aspects; and

FIG. 9 illustrates an example mapping of network metric categories to application-specific use cases for enabling opportunistic connection decisions in accordance with one or more aspects.

### DETAILED DESCRIPTION

### Overview

Mobile network operators (MNOs), such as cellular carriers, can provide connections through a variety of wide-area and local-area wireless networks, including cellular networks, Citizens Broadband Radio Service (CBRS) band networks, WLANs, or the like. As mobile data usage trends continue to rise, deployment or reuse of WLANs or other non-cellular networks can be paramount to increase bandwidth available to users. For example, much of the mobile data usage is concentrated around areas with Wi-Fi networks or hotspots at public locations. Accordingly, MNOs and cellular carriers may utilize such Wi-Fi networks as carrier Wi-Fi networks to augment their cellular networks.

Generally, a mobile device accesses a wireless network through a communication link or “connection” with an AP of the wireless network, base station of a cellular network, or the like. An AP can be any one of a variety of APs, including a public hotspot, a Wi-Fi mesh network, a WLAN router, a combination AP and modem device, and so forth. As the mobile device moves throughout a service area of an MNO or experiences various environmental conditions (e.g., heavy rain, cloud cover), the signal strength of an active connection to an AP or base station may decrease, sometimes to a point of connection loss. To avoid impairment of service, the mobile device may acquire a connection with another base station or AP associated with the MNO. Further, mobile data usage trends indicate that a significant amount of mobile data consumption will be concentrated through Wi-Fi networks at public hotspots. Accordingly, cellular carriers may wish to configure the Wi-Fi networks at these hotspots as carrier Wi-Fi networks or APs to augment their cellular networks. Many mobile devices and mobile operating systems, however, lack native support for deployment of over-the-air (OTA) configurations and credentials for carrier Wi-Fi connections. Further, when carriers or end users install third-party applications to access carrier Wi-Fi networks, the applications lack access to lower-level system information and blindly attempt to connect to any available Wi-Fi carrier AP regardless of connection quality, often resulting in slow or dropped connections.

For example, a default configuration of most mobile operating systems or third-party applications always or automatically connects a mobile device to a Wi-Fi network available through an AP for which the mobile device has credentials. However, this default configuration may not be what a user of the mobile device or wireless carrier desires. In some cases, the Wi-Fi network may experience heavy traffic during certain times of a day or week that limits available bandwidth during those times. If the mobile device automatically connects to the Wi-Fi network during one of those times, the user may experience connection interruptions, slow data transfers, dropped calls, poor audio quality, poor video quality, or the like due to the limited bandwidth. This situation may occur even when signal-related characteristics of the local Wi-Fi network, such as a signal strength, is measured to be sufficient for the mobile device to acquire the connection. Furthermore, a poor or rejected connection may increase signaling overhead, requiring the mobile device to consume significantly more power for data packet retransmissions, which in turn reduces battery life of the device. This poor connectivity and reduced battery life may result in a negative perception of the wireless networks of the carrier and a poor experience for the user.

As another example, a wireless carrier, or other system administrator, may develop a connection management application for installation on mobile devices. However, this approach introduces carrier overhead because carriers and original equipment manufacturers (OEMs) must collaborate to develop the application, which can require different configurations based on the make, model, and operating system (OS) version of the mobile device. Additionally, such applications are typically adopted at low rates by users of mobile devices and the applications are rarely, if ever, updated by the carrier or OEM due to the myriad of unique configuration updates needed to support all the different and legacy mobile devices on the network of the carrier. Ultimately, a poor user experience results from slow data connections, reduced battery life, and fragmented support due to a variety of makes, models, OS versions, and OEMs.

In contrast with these preceding solutions, aspects of policy-defined connection management of opportunistic network capacity may use contextual and other information relating to available wireless connections before attempting to connect or while connected to a Wi-Fi carrier AP. A mobile device having a connection manager may be configured to determine, based on a wireless network policy of the mobile device, contextual and other information for the Wi-Fi carrier AP. In aspects, an administrator of an MNO may generate or configure the wireless network policy for devices associated (e.g., subscribed users) with wireless networks of the MNO. Further, the wireless network policy may be uploaded to the devices of subscribed users via an OTA update, avoiding a fragmented user experience resulting from low adoption rates of carrier-developed connection management applications. The OTA update may include deployment of configurations and credentials useful to access wireless networks and APs of the MNO. The contextual and other information may include a throughput or other performance measurements of the Wi-Fi APs that are accessible by the carrier at a certain time of day or week. If the Wi-Fi carrier AP experiences heavy traffic during certain times, the connection manager may determine to preclude connecting to the Wi-Fi carrier AP at such times, which may avoid connection interruptions and battery drain (e.g., due to data packet retransmission), improving user experience. Further, the connection manager measures signal-related characteristics of the Wi-Fi carrier AP connection and determines, based on the contextual information and the characteristics, a first quality metric. The connection manager also measures second signal-related characteristics of a connection available through a base station of a cellular network associated with the MNO and determines, based on the characteristics, a second quality metric. Based on a comparison of the first and second quality metrics, the connection manager connects the mobile device to the Wi-Fi carrier AP or the cellular network through the base station.

This document describes systems of and techniques for policy-defined connection management of opportunistic network capacity. The disclosed systems and techniques may address the lack of native support of mobile devices or mobile operating systems for integration of carrier Wi-Fi and therefore improve wireless connection performance, reduce network costs, or improve user-device battery life. The following discussion describes operating environments, techniques that may be employed in the operating environments, and example methods. Although systems and techniques directed at policy-defined connection management of opportunistic network capacity are described, the subject of the appended Claims is not necessarily limited to the specific features or methods described. Rather, the specific features and methods are disclosed as example implementations, and reference is made to the operating environment by way of example only.

### Example Environment

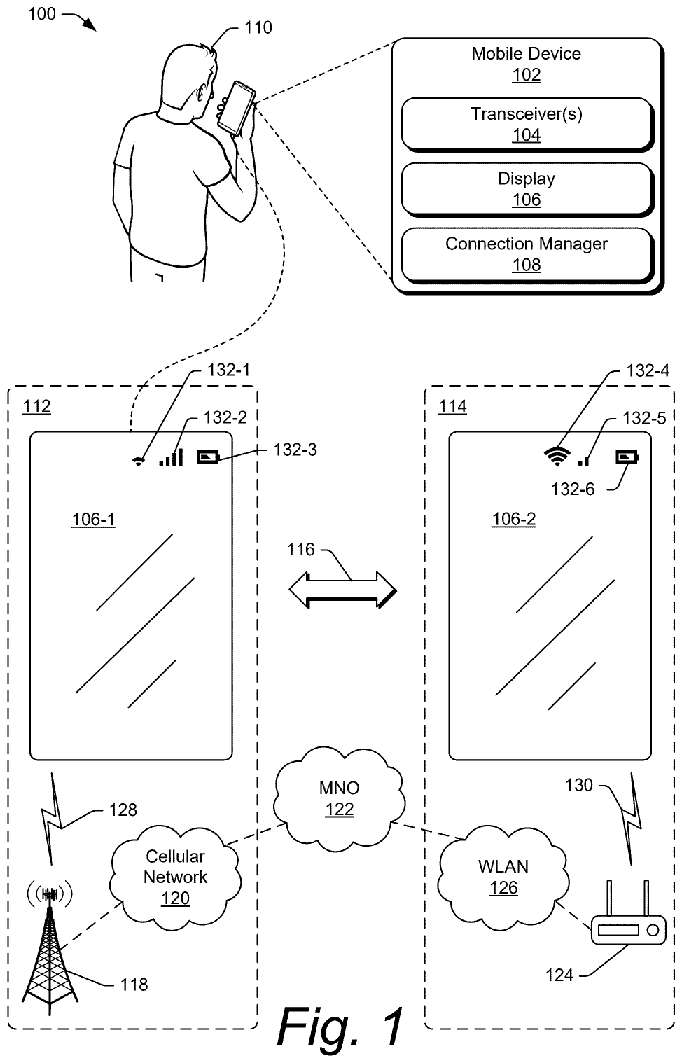

FIG. 1 illustrates an example environment 100 in which a mobile device 102 may implement aspects of policy-defined connection management of opportunistic network capacity. As illustrated, the mobile device 102 includes one or more transceivers 104, a display 106, and a connection manager 108. The transceivers 104 may include any one or more of a WLAN transceiver, a third-generation (3G) mobile network transceiver, a fourth generation (4G) (e.g., Long-Term Evolution transceiver) mobile network transceiver, a fifth generation (5G) mobile network transceiver, a 6G mobile network transceiver, a radio frequency (RF) transceiver, a CBRS transceiver, or other types of transceivers configured to operate on a WLAN, wide area network (WAN), a cellular network, or another wireless network. Additionally, the transceivers 104 may be configured to operate in accordance with any suitable standard or specification, including a respective 3rd Generation Partnership Project (3GPP) standard, IEEE 802.11 standard, 802.15 standard, 802.16 standard, and so forth. The display 106 may include any one or more of a twisted nematic (TN) display, an in-plane switching (IPS) display, a touchscreen display, a light-emitting diode (LED) display, an organic LED (OLED) display, a mini-LED display, or another type of display configured to convey (e.g., visually) information to a user 110 of the mobile device 102. The display 106 may be referred to as a screen, such that content (e.g., images, videos) may be displayed on-screen and the mobile device 102 may receive user input via the screen or other sensors, input systems, or buttons of the mobile device.

The example environment 100 includes a first location 112 (e.g., a mall parking lot) and a second location 114 (e.g., a mall) that are separated by a distance (e.g., a few meters (m), tens of m, hundreds of m). The first location 112 is near a base station 118 (BS 118) of a cellular network 120 (e.g., WAN) associated with an MNO 122. The BS 118 may include any suitable type of base station, which may include a Node B, evolved-node B (eNodeB), next generation Node B (gNB), and so forth. The second location 114 is near an access point 124 (AP 124) of a WLAN 126 associated with the MNO 122. The MNO 122 may include or represent any type of network operator, including a mobile virtual network operator (MVNO), a wireless service provider, a wireless carrier, a cellular company, a mobile network carrier, or any other provider of wireless communications services through at least two types of wireless networks (e.g., WAN, WLAN). At the first location 112, the connection manager 108 may establish or maintain a cellular connection 128 (e.g., wireless connection, wireless link) to the cellular network 120 available through the base station 118. Likewise, at the second location 114, the connection manager 108 may establish or maintain a WLAN connection 130 (e.g., wireless connection, wireless link) to the WLAN 126 available through the AP 124. Alternatively or additionally, the cellular connection 128 and the WLAN connection 130 may be referred to as communication links, radio links, wireless connections, or the like. Furthermore, the cellular connection 128 and the WLAN connection 130 may be implemented as any suitable type or combination of wireless links and may include a downlink of data and control information or an uplink of data and control information. By establishing and managing communication links (e.g., cellular connection 128, WLAN connection 130) to opportunistic network capacity, the connection manager 108 enables the mobile device 102 to transfer data to and from the network of the MNO 122, which may in turn provide access to the Internet (not shown), other data networks, various Internet-of-things (IoT) devices, and other mobile device users seamlessly. Accordingly, when connected to at least one of the MNO's wireless networks, the user 110 may enjoy online multimedia content (e.g., videos, music) and communicate with friends or coworkers (e.g., by text messages, by voice call, by video call) at the first location 112 and the second location 114.

By way of example, at the first and second locations 112 and 114, the display 106 may convey on-screen information to the user 110, including a time, a date, current weather, nearby points of interest, and various status indicators 132 of the mobile device 102 or features thereof. As shown in FIG. 1, at the first location 112, the display 106-1 conveys a Wi-Fi status 132-1, a cellular status 132-2, and a battery status 132-3. In the example, the Wi-Fi status 132-1 and the cellular status 132-2 may include up to four curved and straight bars, respectively, to indicate one or more signal-related characteristics (e.g., received signal strength indicator (RSSI)) of an associated connection. As illustrated, the cellular status 132-2 at the first location 112 near the base station 118 shows four out of four straight bars, indicating that, for example, the RSSI of the cellular connection 128 is high (e.g., −100 decibel-milliwatts (dBm)). The Wi-Fi status 132-1, on the other hand, shows two out of four curved bars, indicating that the RSSI of the WLAN connection 130 available through the AP 124 at the second location 114 some distance (e.g., 100 m) from the first location 112 is low (e.g., −82 dBm). Thus, at the first location 112, the connection manager 108 may connect the mobile device 102 to the cellular network 120 available through the base station 118, thereby directing some or all data traffic (e.g., data, video calls, voice calls, multimedia) through the cellular network 120 of the MNO 122.

At the second location 114, the display 106-2 conveys another set of status indicators, which include another Wi-Fi status 132-4, another cellular status 132-5, and another battery status 132-6 as relating to the second location. The Wi-Fi status 132-4 at the second location 114 near the AP 124 shows four out of four curved bars indicating that, for example, the RSSI of the WLAN connection 130 is high (e.g., −68 dBm). The cellular status 132-5, on the other hand, shows two out of four straight bars, indicating that the RSSI of the cellular connection 128 available through the base station 118 at the first location 112 some distance (e.g., 120 m) from the second location is low (e.g., −112 dBm). Thus, at the second location 114, the connection manager 108 may connect the mobile device 102 to the WLAN 126 available through the AP 124, thereby directing some or all the data traffic through the WLAN 126 of the MNO 122.

As an example of this context, the user 110 of the mobile device 102 travels (e.g., by walking, by vehicle) from the first location 112 to the second location 114 by way of an arrow 116. As the user 110 travels, the connection manager 108 may determine, based on a wireless network policy of the mobile device 102, contextual information for the WLAN connection 130, available through the AP 124, to the WLAN 126 associated with the MNO 122. The wireless network policy may be defined by the MNO 122, and the mobile device 102 may receive the wireless network policy (not shown), for example, via an OTA MNO setting (e.g., carrier setting) update. The OTA update may be associated with a subscriber identity module (SIM) included in the mobile device 102 and the update may include credentials and configurations useful to access the WLAN 126 through the AP 124, or another wireless network and AP associated with the MNO 122. The contextual information for the WLAN connection 130 may include a quality policy, a reputation, a location, an operator, a network type, a cost, or a combination thereof, or it may include other contextual information about the WLAN connection 130 not mentioned.

Additionally, as the user 110 approaches the second location 114, the connection manager 108 may measure (e.g., using the transceivers 104) various first signal-related characteristics, such as the RSSI, of the WLAN connection 130, available through the AP 124, to the WLAN 126 of the MNO 122. In addition to the RSSI, the first signal-related characteristics may include a throughput (e.g., bandwidth), a latency, a jitter, or any other suitable signal-related characteristic of the WLAN connection 130. Based on the contextual information and the first signal-related characteristics, the connection manager 108 may determine a first quality metric (e.g., a number, a ratio) for the WLAN connection 130. In some aspects, the connection manager 108 determines the first quality metric by comparing, for example, one or more elements of the contextual information to a first threshold (e.g., contextual criteria threshold) and one or more of the first signal-related characteristics to a second threshold (e.g., signal criteria threshold). The connection manager 108 may access, obtain, or receive indications of the first and second thresholds from the wireless network policy of the mobile device 102. Additionally or concurrently, the connection manager 108 may measure similar second signal-related characteristics of the cellular connection 128, available through the base station 118, to the cellular network 120. The connection manager 108 may determine, based on the second signal-related characteristics, a second quality metric for the cellular connection 128. The connection manager 108 may determine the second quality metric by comparing one or more of the second signal-related characteristics to a third threshold (e.g., signal criteria threshold), an indication of which may be accessed, obtained, or received by the connection manager 108 from the wireless network policy of the mobile device 102. In aspects, the second threshold and third threshold for signal related criteria may be relatively similar for the respective types of wireless network. In other words, the signal-related characteristics of the cellular connection 128 and the WLAN connection 130 may be compared thresholds (e.g., a value, a range of values, a limit) configured with relatively similar values for each type of wireless access. Thus, the second threshold may include one or more RSSI values to determine a strength (e.g., excellent, high, moderate, low) of a WLAN connection and the third threshold may include one or more other RSSI values to determine a strength (e.g., excellent, high, moderate, low) of a cellular connection. The connection manager 108 may, for example, continually (e.g., every 10 seconds) measure the first and second signal-related characteristics of the WLAN connection 130 and the cellular connection 128, respectively. Similarly, in various aspects, the connection manager 108 may continually compare the first quality metric and the second quality metric to produce a comparison result useful to manage the connections of the mobile device 102 to the cellular network 120 or the WLAN 126.

In the context of the present example, at some distance (e.g., 20 m) from the second location 114, the comparison result of the respective quality metrics may indicate that the WLAN connection 130 is better (e.g., more bandwidth, less jitter) than the cellular connection 128. Based on the comparison result, the connection manager 108 may direct the mobile device 102 to switch connections from the base station 118 to the WLAN 126 through the AP 124 of the MNO 122. By so doing, the connection manager 108 routes some or all traffic (e.g., text messages, voice calls, social media posts) of the mobile device 102 through the better WLAN connection 130. Consequently, the user 110 may experience a seamless transition of routing traffic through the cellular connection 128 to routing traffic through the WLAN connection 130. In other words, the user 110 may not notice any slow down or breaks in streaming multimedia, sending and receiving messages between friends, and so forth. Thus, the connection manager 108 implements aspects of policy-defined connection management of opportunistic network capacity to seamlessly manage connection of the mobile device 102 between carrier Wi-Fi (e.g., WLAN 126) and cellular network based on the network policy of the MNO 122.

As an additional example, after the mobile device 102 connects to the WLAN 126 available through the AP 124, the connection manager 108 may detect (e.g., by the mobile device 102 or components thereof or both) a mobility state of the mobile device 102. For example, the mobility state may indicate whether the mobile device is static in position, or in motion and at what rate of change (e.g., speed, acceleration). In addition to contextual information described in relation to communicative performance (e.g., jitter, latency, cost), the contextual information may also include a mobility threshold. For example, the connection manager 108 may compare the mobility state (e.g., 25 miles per hour (mph)) to the mobility threshold (e.g., 15 mph) to produce a comparison result for the mobility of the mobile device 102. The connection manager 108 may then determine, based on the comparison result, that the mobility state of the mobile device 102 exceeds the mobility threshold and therefore disconnect from the WLAN 126 (e.g., before WLAN connection 130 is lost due to movement away from AP 124). By so doing, the connection manager 108 may avoid connection interruptions that may occur when the user 110 travels near or through, for example, the second location 114 so quickly that connecting to the WLAN 126 results in worse communicative performance than remaining connected to the cellular network 120.

Additionally or alternatively, the comparison result may indicate that the mobile device 102 exceeds the mobility threshold before the connection manager 108 directs the mobile device to connect to the WLAN 126 through the AP 124. In such cases, the connection manager 108 may preclude the mobile device 102 from connecting to the WLAN 126 altogether, thus avoiding potential connection interruptions resulting from acquiring and then losing the WLAN connection 130 in quick succession. Preemptively disconnecting from a wireless network or precluding connection to a wireless network, based on a mobility state of the mobile device 102 or other connection quality metrics, are just two examples of how the connection manager 108 may implement policy-defined connection management of opportunistic network capacity to improve a mobile device user's experience.

### Example Devices

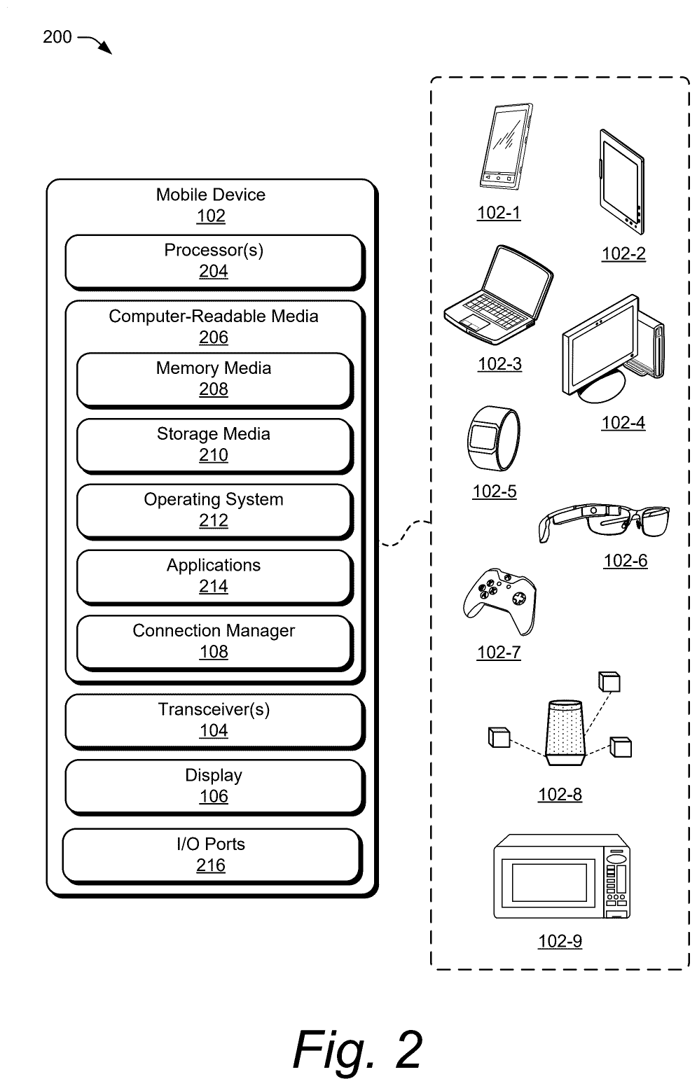

FIG. 2 illustrates at 200 an example configuration of the mobile device 102 from FIG. 1 in more detail. The mobile device 102 is illustrated as a variety of example devices. As non-limiting examples, the mobile device 102 can be a smartphone 102-1, a tablet 102-2, a laptop 102-3, a desktop 102-4, a smartwatch 102-5, a pair of smart glasses 102-6, a game controller 102-7, a smart home speaker 102-8, or a microwave appliance 102-9. Although such examples are not shown, the mobile device 102 can also be an automated teller machine, an audio recording device, a video recording device, a health monitoring device, a home automation system, a home security system, a gaming console, a drone, an IoT device, a home appliance, a sensor, and so forth. The mobile device 102 can be wearable, non-wearable but relatively mobile, or relatively immobile (e.g., a desktop computer). The mobile device 102 can be used with or embedded within many other mobile devices or peripherals, such as in automotive vehicles or an attachment to a desktop. The mobile device 102 may include additional components and interfaces omitted from FIG. 2 for the sake of clarity or brevity.

As illustrated at 200, the mobile device 102 includes one or more processors 204 and computer-readable media 206 (CRM 206). The processors 204 may include one or more of any appropriate single-core or multi-core processors (e.g., central processing unit, graphics processing unit, arithmetic logic unit). The processors 204 may work in tandem with any one or more of the various components illustrated in FIG. 2 to implement aspects of policy-defined connection management of opportunistic network capacity. The CRM 206 may include memory media 208 and storage media 210 of the mobile device 102. The memory media 208 may include any suitable memory media, such as random-access memory (RAM). The RAM may be dynamic RAM (DRAM) or static RAM (SRAM). The storage media 210 may include any suitable storage media or non-volatile media, such as a hard disk drive (HDD), flash media, or a solid-state drive (SSD). In addition to the devices described herein, the memory media 208 and the storage media 210 may include any one or more non-transitory storage devices, each coupled with a data bus, suitable for storing electronic instructions. The term “coupled” may refer to two or more elements that are in direct contact (e.g., physically, electrically, optically) with each other or two or more elements that are not in direct contact but still communicate, cooperate, or interact with each other.

The CRM 206 also includes an operating system (OS) 212, applications 214, and a connection manager 108. In implementations, the OS 212, the applications 214, and the connection manager 108 may be implemented as computer-readable instructions on the CRM 206. For example, the OS 212, the applications 214, and the connection manager 108 may be implemented as computer-readable instructions on the storage media 210. In this way, the OS 212, the applications 214, and the connection manager 108 may be stored for the long term and even while the mobile device 102 is powered off. When the mobile device 102 is powered on, aspects of the OS 212, the applications 214, and the connection manager 108 may be implemented as computer-readable instructions on the memory media 208 that are executed by one or more of processors 204. The processors 204 can execute, for example, the computer-readable instructions stored on the memory media 208 or the storage media 210 to provide some or all the functionalities of the OS 212, the applications 214, or the connection manager 108 described herein. For example, the processors 204 may perform computational tasks of the connection manager 108 directed at implementing various aspects of policy-defined connection management of opportunistic network capacity.

In aspects, various implementations of the connection manager 108 may include one or more integrated circuits, processor-executable instructions, a system-on-chip, a secure key store, hardware embedded (e.g., stored on read-only memory) with firmware, a printed circuit board with various hardware components, firmware elements, or any combination thereof. As described herein, the connection manager 108 may include one or more components of the mobile device 102 configured to implement aspects of policy-defined connection management of opportunistic network capacity. In additional aspects, the connection manager 108 may be implemented as the mobile device 102 and/or in association with the transceivers 104 from which the connection manager 108 may obtain data or other metrics relating to a respective wireless connection or wireless network.

As further illustrated by FIG. 2, the mobile device 102 also includes one or more transceivers 104, a display 106, and one or more input/output (I/O) ports 216. The transceivers 104 may include any one or more of a WLAN transceiver, a 3G mobile network transceiver, a 4G LTE transceiver, a 5G transceiver, a 6G transceiver, an RF transceiver, a CBRS transceiver, or other types of transceivers configured to operate on a WAN, a cellular network, a WLAN, a personal area network (PAN), a mesh network, and so forth. The display 106 may include any one or more of a TN display, an IPS display, a touchscreen display, an LED display, an OLED display, a mini-LED display, or another type of display configured to convey (e.g., visually) information to a user of the mobile device 102. The display 106 may be referred to as a screen, such that content (e.g., images, videos) may be displayed on-screen and may include a touchscreen configured to receive user input. The I/O ports 216 enable the mobile device to interact with other devices or users through peripheral devices, transmitting any combination of power, digital, analog, and RF signals. The I/O ports 216 can include any combination of internal or external ports, such as universal serial bus (USB) ports, audio ports (e.g., auxiliary ports), video ports (e.g., High-Definition Multimedia Interface (HDMI) ports, DisplayPort (DP) ports), dual inline memory module (DIMM) card slots, Peripheral Component Interconnect Express (PCIe) slots, and so forth. Various peripherals, such as human input devices (HIDs), external CRM, speakers, displays, or other peripherals not shown, may be operatively coupled with the I/O ports 216 of the mobile device 102. Although not shown, the mobile device 102 may include a system bus (e.g., a unidirectional bus, a bidirectional bus, a data bus, a command-and-address bus), an interconnect, or a data transfer system that couples with the various components of the mobile device 102. The system bus, the interconnect, or the data transfer system may include any one or a combination of various bus structures, such as a memory bus, a peripheral bus, a USB, or a local bus that utilizes any of a variety of bus architectures.

As described herein, the connection manager 108 may determine contextual information for a wireless connection (e.g., cellular connection 128, WLAN connection 130) available through an AP or base station to a respective wireless network (e.g., cellular network 120, WLAN 126) of an MNO on the basis of a wireless network policy. The wireless network policy may be defined by an MNO (e.g., MNO 122) and deployed to a mobile device (e.g., mobile device 102) via an OTA update. Alternatively or additionally, a wireless network policy (e.g., default or unconfigured policy) may be embedded within a mobile operating system provided by a device manufacturer or distributor. In aspects, the MNO may define or configure the wireless network policy of multiple mobile devices, for example, via a web-based portal or another software-based interface, which may be available to system administrators of the MNO.

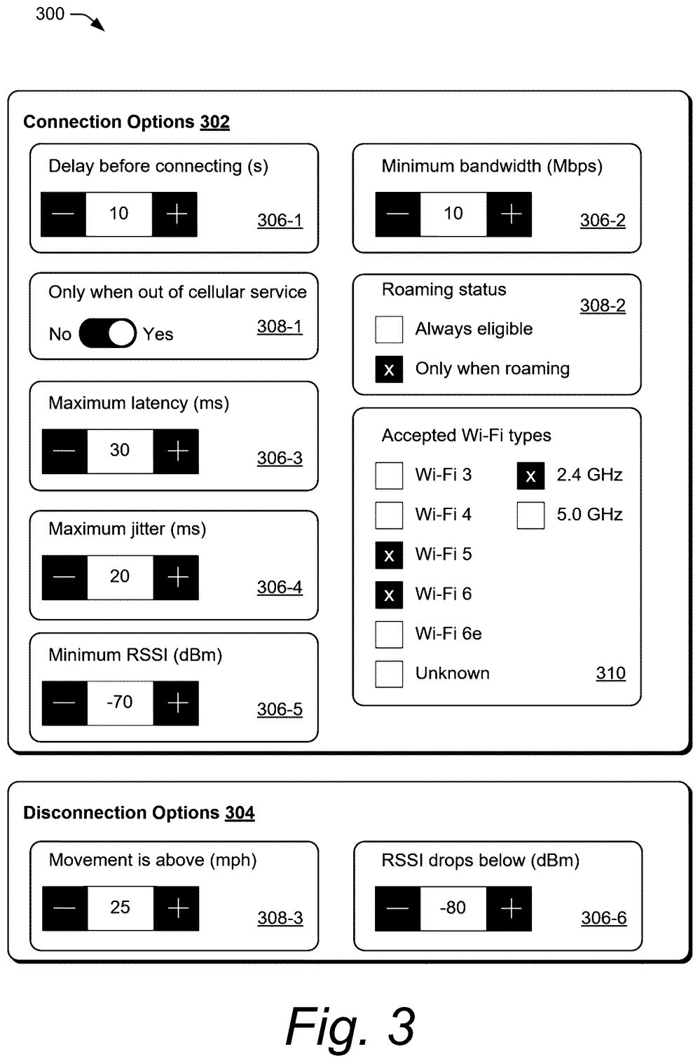

FIG. 3 illustrates at 300 an example implementation of a web-based portal for configuring a wireless network policy in accordance with one or more aspects. In aspects, a system administrator of an MNO (e.g., MNO 122) may use the web-based portal to generate, define, or configure a wireless network policy (e.g., the wireless network policy described with respect to FIG. 1) for mobile devices associated with the MNO (e.g., subscribing devices). In aspects, a wireless network policy system may be implemented as a cloud-based service that provides the web-based portal through which the MNO is able to generate or configure wireless network policies for devices associated (e.g., subscribed users) with the wireless networks of the MNO. As illustrated at 300, the example web-based portal includes connection options 302 and disconnection options 304, which may include respective configurable thresholds (e.g., thresholds described with reference to FIG. 1) to which the connection manager 108 may compare various signal-related characteristics (e.g., latency, jitter) or non-signal related characteristics (e.g., mobility, network congestion, cost) to produce respective comparison results for implementing various aspects of connection management.

As shown in FIG. 3, the connection and disconnection options 302 and 304 include respective threshold options 306, device status options 308, and contextual options 310 for carrier Wi-Fi. The threshold options 306 include a time delay option 306-1, a throughput (or bandwidth) option 306-2, a latency option 306-3, a jitter option 306-4, a connection RSSI option 306-5, and a disconnection RSSI option 306-6. A connection manager (e.g., the connection manager 108) of a mobile device may use the threshold options 306 (e.g., as configured by the MNO) to implement aspects of policy-defined connection management of opportunistic network capacity. In aspects, the connection manager 108 may compare one or more signal-related characteristics of a wireless connection (e.g., cellular connection 128, WLAN connection 130) to a corresponding threshold option 306 to determine, at least in part, a quality metric for the wireless connection. For example, the connection manager 108 may compare a throughput of a wireless connection to the throughput option threshold 306-2 (e.g., 10 megabits per second (Mbps)), a latency to the latency option threshold 306-3 (e.g., 30 milliseconds (ms)), a jitter to the jitter option threshold 306-4 (e.g., 20 ms), or an RSSI to the connection and disconnection RSSI option thresholds 306-5 and 306-6 (e.g., −70 dBm, −80 dBm).

As an example, the connection manager 108 may compare the throughput of the wireless connection to a threshold of 10 Mbps of the throughput option 306-2 to determine a throughput quality metric. As another example, the connection manager 108 may compare the latency of the wireless connection to a threshold of 30 ms of the latency option 306-3 to determine a latency quality metric. As further examples, the connection manager 108 may compare the jitter of the wireless connection to a threshold of 20 ms of the jitter option 306-4, and it may compare the RSSI of the wireless connection to a threshold of −70 dBm of the connection RSSI option 306-5 or a threshold of −80 dBm of the disconnection RSSI option 306-6. The connection manager 108 may determine respective quality metrics for each of the comparisons described herein (e.g., a throughput quality metric for the throughput comparison). The quality metrics of the connection options 302 may indicate, for example, that the wireless connection is eligible for acquisition by the mobile device 102 if one or more of the signal-related characteristics exceeds a respective minimum threshold option 306 (e.g., the throughput exceeds the threshold of the throughput option 306-2) or is below a maximum threshold option 306 (e.g., the latency is below the threshold of the latency option 306-3).

Regarding the device status options 308, the connection manager 108 may compare a current device status to the appropriate device status option 308. For example, the connection manager 108 may compare a service status (measured by transceivers 104) of the mobile device 102 to a cellular service option 308-1. As additional examples, the connection manager 108 may compare a roaming status of the mobile device 102 to a roaming option 308-2 or a mobility status of the mobile device 102 to a mobility status option 308-3. On the basis of these comparisons and, in some examples, others (e.g., network congestion, cost, not shown), the connection manager 108 may produce comparison results, based on which the connection manager may connect to a wireless network.

In the example implementation shown at 300, the contextual option 310 includes accepted Wi-Fi (e.g., WLAN) types, including generational iterations (e.g., Wi-Fi 3, Wi-Fi 4), frequency bands (e.g., 2.4 gigahertz (GHz), 5 GHz), and an unknown option. As illustrated, the MNO has defined the wireless network policy to allow Wi-Fi 5, Wi-Fi 6, and 2.4 GHz connections. For example, and with respect to FIG. 1, the connection manager 108 may compare the Wi-Fi type and/or frequency band of the WLAN connection 130 to the contextual option 310 to produce a comparison result. As an example, assume the WLAN connection 130 to the WLAN 126 uses Wi-Fi 5 and the 2.4 GHz frequency band. Under this assumption, the connection manager 108 may determine to direct the mobile device 102 to connect to the WLAN 126 through the AP 124. As another example, assume the WLAN connection 130 to the WLAN 126 uses Wi-Fi 3 and the 2.4 GHz frequency band. Under this other assumption, given that the WLAN connection uses Wi-Fi 3, the connection manager 108 may determine to direct the mobile device 102 to not connect to the WLAN 126 through the AP 124, even though the WLAN connection uses the 2.4 GHz frequency band.

Further, the connection manager 108 may update (e.g., by the mobile device 102, by the transceivers 104, by an application) the wireless connection policy with the various contextual information and signal-related characteristics measured by the mobile device 102. In this way, the wireless connection policy may include historical information about one or more connections available through one or more APs. The connection manager 108 can determine, based on the historical information, a period of time during which to measure signal-related characteristics of a connection. As an example, if a throughput of a network connection measured by the mobile device 102 is consistently (e.g., a majority of measurements) over 100 Mbps (e.g., a fast network), then the connection manager 108 may determine, on the basis of the updated wireless network policy including the historical information, that frequent measurements for that network are unnecessary. By determining that frequent measurements are unnecessary, the connection manager 108 may not measure signal-related characteristics as often, which can save a battery life of the mobile device 102. Although the throughput of the connection was mentioned, the measurement can include other signal-related characteristics, such as latency, jitter, RSSI, and the like. Furthermore, the measurement can include contextual information, such as a location, a network type (e.g., Wi-Fi 6, CBRS, cellular), device mobility, and the like. As another example, if an RSSI of a network connection measured by the mobile device 102 is weak (e.g., −80 dBm) during lunch hour (e.g., 12:00 to 13:00) at a specific location, the connection manager 108 may determine not to connect to the network connection at that location during lunch hour. By so doing, the connection manager 108 may improve user experience through reduced measurements, increased battery life, and fewer connection interruptions (e.g., by not connecting to the weak connection).

Although not shown, the example implementation 300 of the web-based portal may also include a cellular network policy option interface. In implementations, the contextual options 310 may include accepted cellular network types rather than accepted Wi-Fi types. For example, the accepted cellular network types may include 3G, 4G LTE, 5G, or 6G. Further, given that cellular networks are WANs having stronger signal strengths than carrier Wi-Fi, values of the threshold options 306 may differ compared to the values for carrier Wi-Fi. For example, the minimum RSSI option threshold 306-5 of −70 dBm may be −100 dBm, instead. As another example, the mobility status option threshold 308-3 of 25 mph may be 55 mph instead.

### Example Methods

In the following section, example methods are described that the connection manager from FIG. 1 may perform to implement aspects of policy-defined connection management of opportunistic network capacity. The methods are shown as sets of blocks that specify operations or acts performed at least in part by the connection manager 108, transceivers 104, or mobile device 102. The methods are not necessarily limited to the order or combinations of the sets of blocks shown for performing the operations by the respective blocks. Furthermore, any one or more of the operations may be repeated, combined, reorganized, or linked to provide additional or alternate methods. In the following discussion, reference may be made for example only to the example implementations and entities detailed in FIGS. 1 through 3.

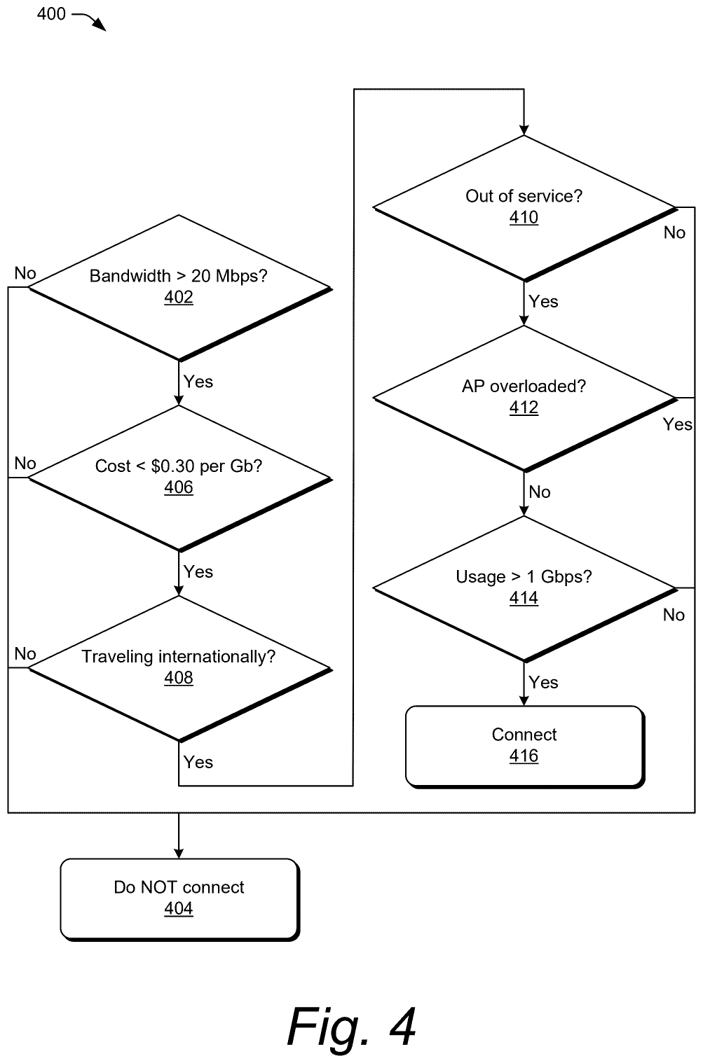

FIG. 4 depicts an example method 400 for determining whether to connect to a wireless network in accordance with one or more aspects. Generally, the operations of method 400 may represent an algorithm or flowchart implemented by the connection manager 108 to determine whether to connect to an available WLAN of an MNO based on various signal-related and non-signal-related criteria in accordance with one or more aspects of policy-defined connection management of opportunistic network capacity. As such, the MNO or network administrator may enable or configure thresholds of the various comparisons of the method 400 implemented by the connection manager 108

At 402, the connection manager determines if a bandwidth (e.g., throughput) of a connection available through an AP of a wireless network associated with an MNO is greater than a bandwidth threshold. In this example, the bandwidth threshold is set at 20 Mbps, but it can be any other threshold, including 10 Mbps, 100 Mbps, 1 Gbps, and so forth. If the bandwidth of the connection is not greater than 20 Mbps, then the connection manager proceeds to operation 404 at which the connection manager does not connect to the AP of the WLAN. Otherwise, if the bandwidth is greater than 20 Mbps, then the connection manager proceeds to a next operation of the method 400.

At 406, the connection manager determines if a cost of the connection to the WLAN is less than a cost threshold. In this example, the cost threshold is $0.30 per Gb, but it can be any other threshold, including $0.50 per Gb, $1.0 per Gb, $10 per Gb, and so forth. If the cost is not less than $0.30, then the connection manager proceeds to operation 404 at which the connection manager does not connect to the AP of the WLAN. Otherwise, if the cost is less than $0.30, the connection manager proceeds to operation 408 of the method 400.

At 408, the connection manager determines if a user of the mobile device with the available connection is traveling internationally. The connection manager determine the travel or roaming status of the user based on a mobility of the device, a mobile country code (MCC) in use by the device, and/or location status of the mobile device. In some cases, the user of the mobile device is provided with controls allowing the user to decide if or when the connection manager may collect sensitive information, such as the mobility or location status of the mobile device. If the user is not traveling internationally, the connection manager proceeds to operation 404 at which the connection manager does not connect to the AP of the WLAN. Otherwise, if the user is traveling internationally, the connection manager proceeds to a next operation of the method 400.

At 410, the connection manager determines (e.g., by transceivers 104) if the mobile device is out of service (e.g., outside of a cellular service area). If the mobile device is not out of service, then the connection manager proceeds to operation 404 at which the connection manager does not connect to the AP of the WLAN. Otherwise, if the mobile device is out of service, the connection manager proceeds to operation 412 of the method 400.

At 412, the connection manager determines if the AP to the WLAN associated with the MNO is overloaded. For example, the AP may be overloaded during high traffic times, such as lunch hour or dinner time. If the AP is overloaded, the connection manager proceeds to 416, at which point the connection manager does not connect to the wireless network. Otherwise, if the closest AP is not overloaded, the connection manager proceeds to a next operation of the method 400.

At 414, the connection manager determines if a current data usage of the mobile device is greater than a usage threshold. In this example, the usage threshold is 1 Gbps, but it can be any threshold, including 0.5 Gbps, 2 Gbps, 10 Gbps, and so forth. If the current data usage is not greater than 1 Gbps, the connection manager proceeds to 404, at which point the connection manager does not connect to the WLAN. Otherwise, if the current data usage is greater than 1 Gbps, the connection manager proceeds to operation 416 of the method 400. At 416, the connection manager connects (e.g., by directing the mobile device 102 to utilize the transceivers 104) to the wireless network available through the AP of the WLAN associated with the MNO. From operation 416, the method may return to any operation of the method 400 and evaluate available cellular networks or other WLANs available through the MNO to optimize the connection with one of the MNO's available wireless networks.

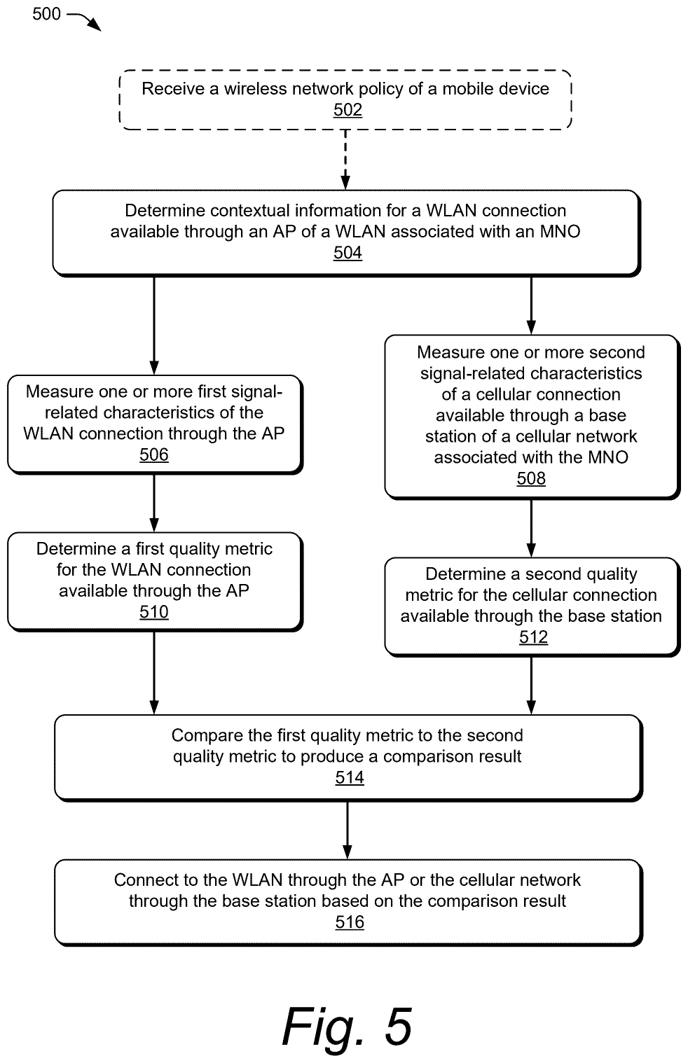

FIG. 5 illustrates an example method 500 for managing a connection to a WLAN through an AP or to a cellular network through a base station. Optionally, at 502, a connection manager receives a wireless network policy of a mobile device. As described herein, the wireless network policy may be defined by an MNO and received by the connection manager via an OTA carrier settings update. The connection manager may receive the wireless network policy when a user (e.g., user 110) installs a SIM card into a mobile device 102. Alternatively, because the connection manager may share information about the mobile device, including location and mobility information, the connection manager may receive the wireless network policy after the user gives permission to share said information. In some cases, the MNO may also push updates of the wireless network policy to dynamically update parameters for connection management. For example, if a base station becomes inoperable, the MNO may alter connection parameters of the wireless network policy of multiple mobile devices proximate the base station to direct the mobile devices to connect to other base stations or WLANs in the area.

At 504, the connection manager determines contextual information for a WLAN connection (e.g., WLAN connection 130) available through an AP (e.g., AP 124) to a WLAN (e.g., WLAN 126) associated with an MNO (e.g., MNO 122). The contextual information may include, as described herein, a Wi-Fi generation or a frequency band of the WLAN connection. Alternatively or additionally, the contextual information may include historical network performance, current network congestion (obtained from the MNO), throughput, jitter, latency, and so forth.

At 506, the connection manager measures one or more first signal-related characteristics of the WLAN connection available through the AP. Similarly, at 508, the connection manager measures one or more second signal-related characteristics of a cellular connection (e.g., cellular connection 128) available through a base station (e.g., another AP, base station 118) to a cellular network (e.g., cellular network 120) associated with the MNO. As described herein, the first and second signal-related characteristics may include, for a respective connection, a throughput, a latency, a jitter, an RSSI, and so forth.

At 510, the connection manager determines a first quality metric for the WLAN connection available through the AP. The determination may be based on, for example, the contextual information for the WLAN and the first signal-related characteristics of the WLAN connection measured at 506. Similarly, at 512, the connection manager determines a second quality metric for the cellular connection available through the base station. This determination may be based on, for example, the second signal-related characteristics of the cellular connection measured at 510 and/or contextual information related to the cellular network (e.g., roaming, cell network congestion, cost). The first and second quality metrics may be a whole number, a fraction, a Boolean value, or another metric usable by the connection manager to compare the available connections of the wireless networks. The first and second quality metrics may represent a specific signal-related characteristic (e.g., RSSI) that the MNO prioritizes, or they may represent a combined value of two or more signal-related characteristics and/or non-signal related characteristics, such as a weighted average.

At 514, the connection manager compares the first quality metric to the second quality metric to produce a comparison result. For example, the comparison result may indicate that the WLAN available through the AP is likely to offer better performance (e.g., higher RSSI, less jitter, less latency) than the cellular connection provided by the base station. As a second example, the comparison result may indicate that the WLAN connection through the AP is of lower quality (e.g., lower RSSI, more jitter, more latency) than the cellular connection through the base station. As a third example, the comparison result may indicate that neither the WLAN connection through the AP nor the cellular connection through the base station is better than the other. In such cases, the method 500 may return to operation 502 to implement another iteration to re-evaluate available networks.

At 516, the connection manager connects to either the WLAN through the AP or the cellular network through the base station of the MNO. The connection manager may, for example, connect to the selected wireless network based on the comparison result provided at operation 514. For example, if the comparison result indicates that the WLAN connection through the AP offers better performance than the cellular connection through the base station, the connection manager connects (or maintains a connection) to the WLAN through the AP. Alternatively, if the comparison result indicates that the WLAN connection through the AP will not perform as well as the cellular connection through the base station, the connection manager connects (or maintains a connection) to the cellular network through the base station.

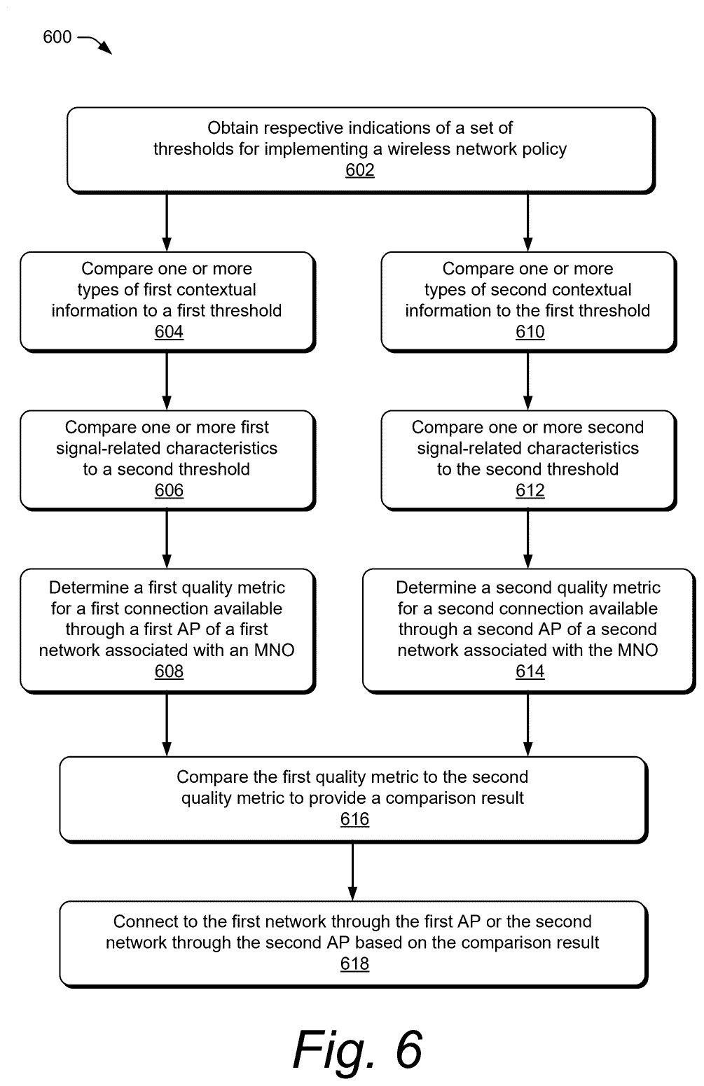

FIG. 6 illustrates an example method 600 for managing a connection between a first network through a first AP or a second network through a second AP. As an example, the connection manager 108 may implement the method 600 when the mobile device 102 is within range of two or more WLANs or carrier Wi-Fi APs of an MNO 122.

At 602, a connection manager obtains indications of a set of thresholds for implementing a wireless network policy. The connection manager may obtain, access, or receive the indications of the thresholds from a wireless network policy maintained on a mobile device in which the connection manager is embodied. The set of thresholds may include at least a first threshold and a second threshold of a wireless network policy, which may be received from or configured by the MNO. The thresholds may be a whole number, a fraction, a range of whole numbers or fractions, or a combination thereof. The thresholds can include, for example, a minimum RSSI, a maximum jitter, or a maximum latency.

At 604, the connection manager compares one or more types of first contextual information (e.g., the contextual information of FIG. 5) relating to the first network through the first AP to the first threshold. The contextual information can include a wireless network type or configuration, a historical usage pattern (e.g., throughput at a time of a day or week), a location, a cost per gigabit (Gb), and so forth. At 606, the connection manager compares one or more first signal-related characteristics (e.g., the first signal-related characteristics of FIG. 5) relating to the first network to the second threshold.

At 608, the connection manager determines a first quality metric for the first connection available through the first AP to the first network associated with the MNO. The connection manager may make this determination based on the comparison of the first contextual information to the first threshold at 604 and/or the comparison of the first signal-related characteristics to the second threshold at 606.

At 610, the connection manager compares one or more types of second contextual information relating to the second network through the second AP to the first threshold. The contextual information can include a wireless network type or configuration, a historical usage pattern (e.g., throughput at a time of a day or week), a location, a cost per Gb, and the like. In some aspects, respective thresholds for contextual information of the first network and second network may be different or configured differently, which may include a modifier for network-specific preferences (e.g., congestion or load balancing). At 612, the connection manager compares one or more second signal-related characteristics relating to the second network to the second threshold.

At 614, the connection manager determines a second quality metric for the second connection available through the second AP to the second network associated with the MNO. The connection manager may make this determination based on the comparison of the second contextual information to the first threshold at 610 and/or the comparison of the second signal-related characteristics to the second threshold at 612.

At 616, the connection manager compares the first quality metric to the second quality metric to produce a comparison result. The comparison result may indicate whether the first or second connection is superior or provides better service in accordance with the criteria of wireless network policy. At 618, the connection manager connects to either the first network through the first AP or the second network through the second AP. The connection manager may make this connection based on the comparison result produced at 616.

The first and second networks described in relation to FIG. 6 may be any wireless network associated with the MNO. For example, the first network may be a mesh network, a peer-to-peer network, a Wi-Fi network (e.g., WLAN 126), or another wireless network associated with the MNO. Likewise, the second network may be a cellular network, a Wi-Fi network, or another wireless network associated with the MNO. Alternatively, the first and second networks may be a CBRS network, a 5 GHz frequency band network, a 2.4 GHz frequency band network, or even a wireless network associated with a different MNO. The first and second APs may be any APs associated with the wireless networks. For example, the APs may be base stations (e.g., base station 118) for a cellular network or networks, routers (e.g., AP 124) for a WLAN or Wi-Fi network, antennas for a CBRS network, satellite dishes for a satellite network, and so forth. The MNO described in FIG. 6 may be any MNO, MVNO, wireless carrier, or provider of wireless communications services.

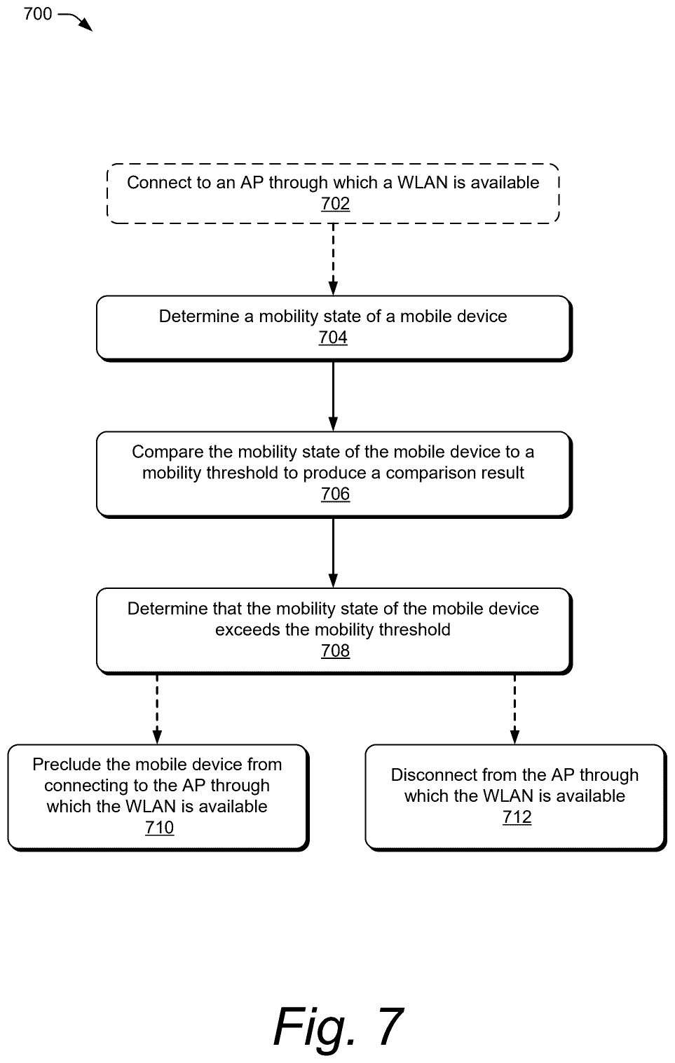

FIG. 7 illustrates an example method 700 for managing a wireless network connection of a mobile device based on mobility of the mobile device. Optionally, at 702, a connection manager connects a mobile device to an AP through which a WLAN is available, including using aspects described herein. At 704, the connection manager determines a mobility state of the mobile device. The mobility state may include a motion status (e.g., stationary, mobile), acceleration measurement, a speed (e.g., 10 mph), or a vector (e.g., southeast) indicating movement of the mobile device. The connection manager may determine the mobility state or obtain information to do so from one or more sensors of the mobile device, such as a Global Positioning System (GPS) module, motion sensor, gyroscope, or accelerometer.

At 706, the connection manager compares the mobility state of the mobile device to a mobility threshold of a wireless network policy of the mobile device to produce a comparison result. An MNO or cellular carrier may define or configure the mobility threshold of the wireless network policy maintained by the mobile device. As such, the connection manager may obtain, access, or receive an indication of the mobility threshold from the wireless network policy. The mobility threshold may include a maximum speed, which may include by way of example 10 mph, 15 mph, 25 mph, or the like.

At 708, the connection manager determines that the mobility state of the mobile device exceeds the mobility threshold. As an example, a user (e.g., user 110) may be traveling quickly (e.g., 75 mph) by vehicle (e.g., on an interstate) past a location (e.g., second location 114) with an AP (e.g., AP 124) to a wireless network (e.g., WLAN 126) associated with an MNO (e.g., MNO 122). If the mobility threshold is 15 mph, in the context of the present example, then the connection manager determines that the mobility state of 75 mph exceeds the 15 mph threshold.

Assume that the connection manager did not perform operation 702 of the method 700 and thus did not connect the mobile device to the AP through which the WLAN is available. Under this assumption, at 710, the connection manager precludes the mobile device from connecting to the AP through which the WLAN is available in response to the mobility state of the mobile device exceeding the mobility threshold. Alternatively, assume that the connection manager did perform operation 702 of the method 700 and thus connected the mobile device to the AP through which the WLAN is available. Under this assumption, at 712, the connection manager disconnects from the AP through which the WLAN is available in response to the mobility state of the mobile device exceeding the mobility threshold. For example, the connection manager may disconnect from the WLAN given that the user will not be in a range of the AP in a relatively short time when traveling at 75 mph. In another example, the connection manager may preclude the mobile device from connecting to the AP through which the WLAN is available, given that the user will not likely be in the range of the AP to facilitate a useful connection with the WLAN. By so doing, the connection manager may improve user experience by maintaining connection with a cellular network and avoiding connection interruptions when attempting to connect to a WLAN with transitory availability.

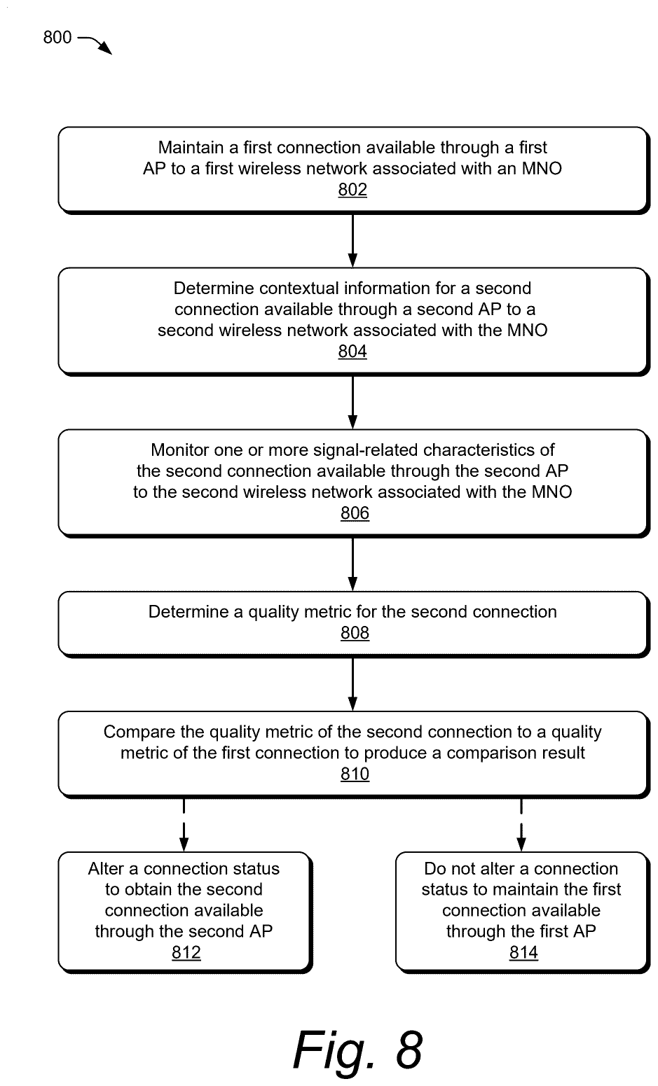

FIG. 8 illustrates an example method 800 for altering a connection status to a first AP based on relative quality metrics of a second AP in accordance with one or more aspects. At 802, a connection manager maintains the first connection available through the first AP to a first wireless network associated with an MNO. For example, the first connection may be the cellular connection 128 of FIG. 1, the second connection may be the WLAN connection 130 of FIG. 1, and the MNO may be the MNO 122 of FIG. 1. Generally, the connection manager may also determine and maintain contextual information, measurements of signal-related characteristics, and quality metrics for the first connection to the first AP of the first WLAN.

At 804, the connection manager determines contextual information for the second connection available through the second AP to a second wireless network associated with the MNO. The contextual information may include historical information about the second connection or the second AP, including, for example, during which times traffic is light (e.g., available bandwidth) or heavy (e.g., limited bandwidth), a variance in throughput with respect to time, and a variance in latency with respect to time. The contextual information may also include real-time information including a cost-per-Gb, a location, or another real-time network-quality factor. The connection manager may determine the contextual information based on criteria defined by a wireless network policy of the mobile device.

At 806, the connection manager monitors one or more signal-related characteristics (e.g., throughput, latency, jitter, RSSI) of the second connection available through the second AP to the second wireless network associated with the MNO. The connection manager may monitor the signal-related characteristics by, for example, measuring them, using the mobile device or sensors thereof (e.g., transceivers 104) at a predetermined rate. The predetermined rate (e.g., every 5 minutes) may be included in the wireless network policy and may be based on previous measurements of the signal-related characteristics of the second connection.

At 808, the connection manager determines a quality metric for the second connection available through the second AP. The connection manager may make this determination based on the contextual information for and the signal-related characteristics of the second connection available through the second AP. The contextual information and signal-related characteristics may be compared to a threshold (e.g., first, second, or third thresholds of FIG. 6) to produce a comparison result, upon which the connection manager may also base the determination of the second quality metric.

At 810, the connection manager compares the quality metric of the first connection to the quality metric of the second connection to produce a comparison result. The comparison result may be a number, a fraction, a Boolean value, or another numerical or logical value. The comparison result may indicate that the first connection offers better performance than the second connection, the second connection offers better performance than the first connection, or the first and second connections are equal. If the comparison result indicates that the first and second connections are equal, the connection manager may maintain the first connection in order to avoid data disruptions. Alternatively or additionally, the connection manager may return to operation 802 to implement another iteration of the method 800.

Optionally at 812, the connection manager alters a connection status of the mobile device to obtain the second connection available through the second AP. The connection manager may alter the connection status to obtain the second connection based on the comparison result produced at 810. For example, if the comparison result indicates that the second connection is better than the first connection, altering the connection status may include causing a transceiver of the mobile device to obtain the second connection available through the second AP to the second WLAN associated with the MNO. Alternatively, altering the connection status may include, based on the comparison result, disconnecting from the first connection and obtaining a connection with a cellular network instead of the second WLAN.

Optionally at 814, the connection manager does not alter the connection status of the mobile device to maintain the first connection available through the first AP. The connection manager may determine to not alter the connection status with the first AP of the first WLAN based on the comparison result produced at 810. For example, if the comparison result indicates that the first connection is better than the second connection, not altering the connection status may include maintaining the first connection to the first AP of the first WLAN associated with the MNO.

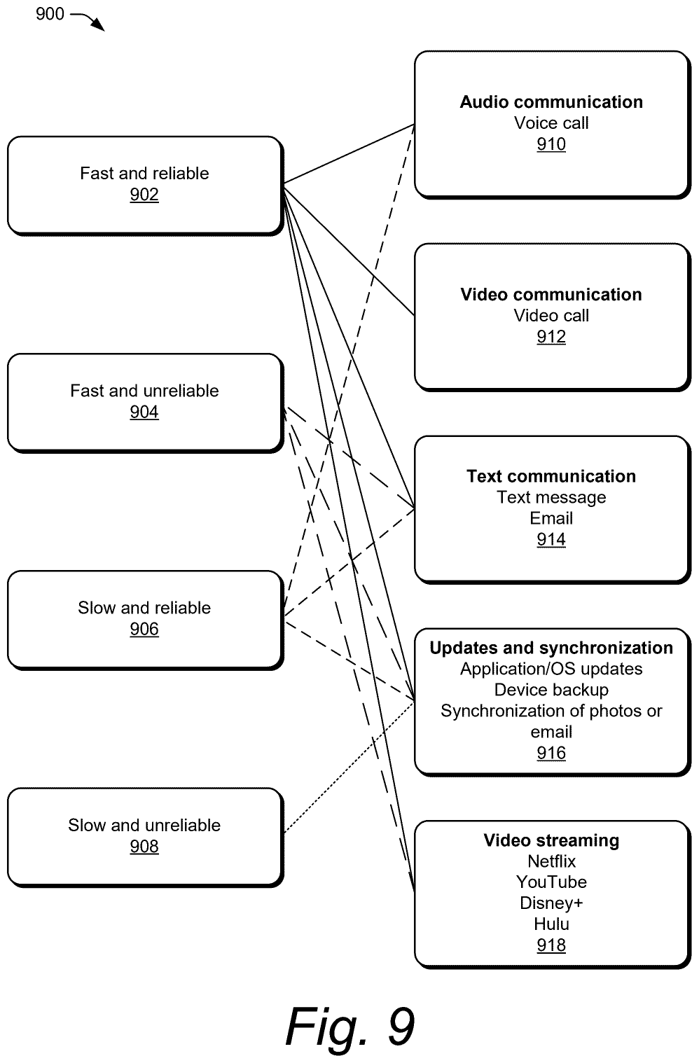

FIG. 9 illustrates at 900 an example of mapping of network metric categories to application-specific use cases for enabling opportunistic connection decisions in accordance with one or more aspects. The example mapping is illustrated at 900 as a left-hand column of blocks and a right-hand column of blocks. In accordance with various aspects, the left-hand column of blocks includes various network metric descriptors of a wireless connection (e.g., the first or second connection from FIG. 8). These descriptors include fast and reliable 902, fast and unreliable 904, slow and reliable 906, and slow and unreliable 908. The descriptors may describe or represent, for example, first, second, third, and fourth connections available through respective first, second, third, and fourth APs that provide carrier Wi-Fi for an MNO.

The right-hand column of blocks includes various descriptors of application-specific wireless traffic or traffic classes. These descriptors include audio communication 910 (e.g., a voice call), video communication 912 (e.g., a video call), text communication 914 (e.g., an SMS message, an email), updates and synchronization 916 (e.g., application updates, OS updates, device backup, photo synchronization, email synchronization), and video streaming 918 (e.g., watching movies), which may be categorized in accordance with criteria defined by the MNO.

As shown in FIG. 9, the network metric descriptors 902 through 908 are connected by respective line types to the right-hand application-specific descriptor blocks. Any one or more of methods described herein may be implemented for application-specific connection management. That is, rather than routing all data through a newly acquired connection, a connection manager may route data for one or more applications through the newly acquired connection. For example, the connection manager may route data through the fast and reliable 902 connection for applications including audio communication 910, video communication 912, text communication 914, updates and synchronization 916, and video streaming 918, as indicated by solid connecting lines. As another example, the connection manager may route data through the fast and unreliable 904 connection for applications including text communication 914, updates and synchronization 916, and video streaming 918, as indicated by long-dashed connecting lines. The connection manager may route data through the slow and reliable 906 connection for applications including audio communication 910, video communication 912, and updates and synchronization 916, as indicated by short-dashed connecting lines. The connection manager may route data through the slow and unreliable 908 connection for updates and synchronization 916 applications, as indicated by a dotted line.

Further, although not shown, any one of the methods described herein may be application-specific depending on a usage state of an application. For example, a user (e.g., user 110) may be in an audio or video call with a friend as he travels from a first location (e.g., first location 112, a mall parking lot) to a second location (e.g., second location 114, a mall). The first location may have a first connection available to a first network associated with an MNO. The second location may have a second connection available to a second network associated with the MNO. For example, the first connection may be a cellular connection available through a base station in the mall parking lot, and the second connection may be a Wi-Fi connection available through a router inside the mall. As the user travels inside the mall, rather than routing data for the audio or video call through the second connection, the connection manager may continue routing said data through the first connection. By so doing, the connection manager prevents connection drops or interruptions for the audio or voice call, improving user experience through policy-defined connection management of opportunistic network capacity.

### ADDITIONAL EXAMPLES

In the following section, additional examples are provided.

Example 1: A method performed by a mobile device, the method comprising: determining, based on a wireless network policy of the mobile device, contextual information for a wireless local area network (WLAN) connection available through an access point (AP) to a WLAN associated with a mobile network operator (MNO); measuring, by the mobile device, one or more first signal-related characteristics of the WLAN connection available through the AP; determining, based on the contextual information and the first signal-related characteristics, a first quality metric for the WLAN connection available through the AP; measuring, by the mobile device, one or more second signal-related characteristics of a cellular network connection available through a base station to a cellular network associated with the MNO; determining, based on the second signal-related characteristics, a second quality metric for the cellular network connection available through the base station; comparing, by the mobile device, the first quality metric to the second quality metric to produce a comparison result; and connecting, based on the comparison result, to either the WLAN through the AP or the cellular network through the base station.

Example 2: The method of example 1, wherein: the comparison result indicates that the first quality metric of the WLAN connection is higher than the second quality metric of the cellular connection, and the method further comprises connecting to the WLAN connection through the AP; or the comparison result indicates that the second quality metric of the cellular connection is higher than the first quality metric of the WLAN connection, and the method further comprises connecting to the cellular connection through the base station.

Example 3: The method of example 1, further comprising: receiving, by the mobile device, the wireless network policy of the mobile device from the MNO.

Example 4: The method of example 3, wherein the wireless network policy of the mobile device is received from the MNO through an over-the-air MNO update of the mobile device.

Example 5: The method of any one of examples 1 to 4, wherein the wireless network policy specifies the contextual information and the wireless network policy is defined by the MNO.

Example 6: The method of any one of examples 1 to 5, wherein the contextual information for the WLAN associated with the MNO comprises at least one of a quality policy, a reputation, a location, an operator, a network type, or a cost.

Example 7: The method of any one of examples 1 to 6, wherein the one or more first signal-related characteristics comprise at least one of a data throughput, a data latency, or a jitter metric of the connection with the WLAN.

Example 8: The method of any one of examples 1 to 7, wherein the one or more first signal-related characteristics comprise a signal strength of the connection with the WLAN.

Example 9: The method of any one of examples 1 to 8, wherein determining the first quality metric comprises comparing one or more types of the contextual information to a first threshold of the wireless network policy.

Example 10: The method of example 9, further comprising: obtaining, by the mobile device, an indication of the first threshold from the wireless network policy.

Example 11: The method of any one of examples 1 to 10, wherein determining the first quality metric comprises comparing one or more of the first signal-related characteristics to a second threshold of the wireless network policy.

Example 12: The method of example 11, further comprising: obtaining, by the mobile device, an indication of the second threshold from the wireless network policy.

Example 13: The method of any one of examples 1 to 12, wherein determining the second quality metric comprises comparing one or more of the second signal-related characteristics to a third threshold of the wireless network policy.

Example 14: The method of example 13, further comprising: obtaining, by the mobile device, an indication of the third threshold from the wireless network policy.

Example 15: The method of any one of examples 1 to 14, wherein the contextual information comprises a mobility state of the mobile device, and the method further comprises: detecting, by the mobile device, the mobility state of the mobile device; comparing, by the mobile device, the mobility state of the mobile device to a mobility threshold to produce a comparison result; determining, based on the comparison result, that the mobility state of the mobile device exceeds the mobility threshold; and precluding, in response to the determination, the mobile device from connecting to the AP through which the WLAN is available; or disconnecting, in response to the determination, from the AP through which the WLAN is available.

Example 16: The method of any one of examples 1 to 15, wherein the MNO is one of a mobile virtual network operator (MVNO), a wireless service provider, a wireless carrier, a cellular company, or a mobile network carrier.

Example 17: The method of any one of examples 1 to 16, wherein connecting to either the WLAN through the AP or the cellular network through the base station is application-specific.

Example 18: A method performed by a mobile device, the method comprising: maintaining, by the mobile device, a first connection available through a first AP to a first wireless network associated with an MNO, the first connection having a first quality metric; determining, based on a wireless network policy of the mobile device, contextual information for a second connection available through a second AP to a second wireless network associated with the MNO; monitoring, by the mobile device, one or more signal-related characteristics of the second connection available through the second AP to the second wireless network associated with the MNO; determining, based on the contextual information and the second signal-related characteristics, a second quality metric for the second connection; comparing, by the mobile device, the first quality metric to the second quality metric to produce a comparison result; and altering, based on the comparison result, a connection status to either the first connection available through the first AP or the second connection available through the second AP.

Example 19: The method of example 18, wherein altering the connection status includes remaining connected to the first connection.

Example 20: The method of example 18, wherein altering the connection status includes connecting to the second connection.

Example 21: The method of any one of examples 1 to 17, further comprising: determining, based on the wireless network policy, a period of time during which to measure the one or more first signal-related characteristics of the WLAN connection available through the AP; measuring, by the mobile device and during the period of time, the first signal-related characteristics of the WLAN connection available through the AP to produce one or more signal-related measurements; and updating, by the mobile device, the wireless connection policy with the one or more signal-related measurements.

Example 22: A mobile device comprising: one or more transceivers; one or more processors; and memory storing: instructions that, when executed by the one or more processors, implement a connection manager to implement any one of the methods of claims 1 to 20.

Example 23: A method comprising: presenting a user interface (UI) to a user, the UI including connection options and disconnection options of a wireless network policy for a mobile device of an MNO; receiving, from the user, selections of the connection and disconnection options; generating, based on the selections received from the user, the wireless network policy for the mobile device; configuring an over-the-air (OTA) update for the mobile device that includes the wireless network policy; and transmitting the OTA update to the mobile device, the OTA update effective to cause the mobile device to manage connections to a WLAN associated with the MNO or a cellular network associated with the MNO in accordance with the wireless network policy.

Example 24: The method of example 23, wherein the method is implemented at least partially through a cloud-based service.

Example 25: The method of example 23 or 24, wherein the wireless network policy comprises a configuration and credentials for the WLAN associated with the MNO.

Example 26: The method of example 23, 24 or 25, wherein: the wireless network policy specifies contextual information for the WLAN associated with the MNO, the contextual information comprising at least one of a quality policy, a reputation, a location, an operator, a network type, a cost or a mobility state of the mobile device.

Example 27: The method of any one of examples 23 to 26, wherein: the connection and disconnection options include respective configurable thresholds; and the selections received from the user configure at least one of the respective configurable thresholds.

Example 28: The method of any one of examples 23 to 27, wherein the MNO is one of an MVNO, a wireless service provider, a wireless carrier, a cellular company, a mobile network carrier, or an administrator thereof.

Example 29: The method of any one of examples 23 to 28, wherein transmitting the OTA update includes transmitting the OTA update to multiple mobile devices associated with the MNO.

Example 30: A computer-readable storage medium comprising instructions which, when executed by one or more processors, cause any one of the methods of examples 1 to 21 or 23 to 29 to be carried out.

### CONCLUSION

Throughout this discussion, an example is described where a connection manager of a mobile device (e.g., a smartphone) measures information (e.g., a location, a mobility state) associated with a user. In addition to the descriptions above, the user may be provided with controls allowing the user to decide if and when systems, programs, and/or features described herein may enable collection of user information (e.g., connection duration information, signal quality information, network identity information, recently utilized wireless communication channels, the user's preferences, the user's current location) and if the user is sent content and/or communication from a server. In addition, certain data may be treated in one or more ways before it is stored or used so that personally identifiable information is removed. For example, the user's identity may be treated so that no personally identifiable information can be determined for the user. For example, the user's geographic location may be generalized to a city, postal code, state, or province, so that a particular location of the user cannot be determined. Thus, the user may have control over what information is collected about the user, how that information is used, and what information is provided to the user.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations of systems and techniques of, as well as apparatuses enabling, policy-defined connection management of opportunistic network capacity have been described in language specific to certain features and/or methods, the subject of the appended Claims is not necessarily limited to the specific features or methods described. Rather, the specific features and methods are disclosed as example implementations of policy-defined connection management of opportunistic network capacity.

1. A method performed by a mobile device, the method comprising:
determining, based on a wireless network policy of the mobile device, contextual information for a wireless local area network (WLAN) connection available through an access point (AP) to a WLAN associated with a mobile network operator (MNO);
measuring, by the mobile device, one or more first signal-related characteristics of the WLAN connection available through the AP;
determining, based on the contextual information and the first signal-related characteristics, a first quality metric for the WLAN connection available through the AP;
measuring, by the mobile device, one or more second signal-related characteristics of a cellular network connection available through a base station to a cellular network associated with the MNO;
determining, based on the second signal-related characteristics, a second quality metric for the cellular network connection available through the base station;
comparing, by the mobile device, the first quality metric to the second quality metric to produce a comparison result; and
connecting, based on the comparison result, to either the WLAN through the AP or the cellular network through the base station.

2. The method of claim 1, wherein:
the comparison result indicates that the first quality metric of the WLAN connection is higher than the second quality metric of the cellular connection, and the method further comprises connecting to the WLAN connection through the AP; or
the comparison result indicates that the second quality metric of the cellular connection is higher than the first quality metric of the WLAN connection, and the method further comprises connecting to the cellular connection through the base station.

3. The method of claim 1, further comprising:
receiving, by the mobile device, the wireless network policy of the mobile device from the MNO.

4. The method of claim 3, wherein the wireless network policy of the mobile device is received from the MNO through an over-the-air MNO update of the mobile device.

5. The method of claim 1, wherein the wireless network policy specifies the contextual information and the wireless network policy is defined by the MNO.

6.-11. (canceled)

12. The method of claim 11, further comprising:
obtaining, by the mobile device, an indication of the second threshold from the wireless network policy.

13. The method of claim 1, wherein determining the second quality metric comprises comparing one or more of the second signal-related characteristics to a third threshold of the wireless network policy.

14. The method of claim 13, further comprising:
obtaining, by the mobile device, an indication of the third threshold from the wireless network policy.

15. The method of claim 1, wherein the contextual information comprises a mobility state of the mobile device, and the method further comprises:
detecting, by the mobile device, the mobility state of the mobile device;
comparing, by the mobile device, the mobility state of the mobile device to a mobility threshold to produce a comparison result;
determining, based on the comparison result, that the mobility state of the mobile device exceeds the mobility threshold; and
precluding, in response to the determination, the mobile device from connecting to the AP through which the WLAN is available; or
disconnecting, in response to the determination, from the AP through which the WLAN is available.

16. A mobile device comprising:
one or more transceivers;
one or more processors; and
a memory storing;
instructions that, when executed by the one or more processors, implement a connection manager to:
determine, based on a wireless network policy of the mobile device, contextual information for a wireless local area network (WLAN) connection available through an access point (AP) to a WLAN associated with a mobile network operator (MNO);
measure one or more first signal-related characteristics of the WLAN connection available through the AP;
determine, based on the contextual information and the first signal-related characteristics, a first quality metric for the WLAN connection available through the AP;
measure one or more second signal-related characteristics of a cellular network connection available through a base station to a cellular network associated with the MNO;
determine, based on the second signal-related characteristics, a second quality metric for the cellular network connection available through the base station;
compare the first quality metric to the second quality metric to produce a comparison result; and
connect, based on the comparison result, to either the WLAN through the AP or the cellular network through the base station.

17. The mobile device of claim 16, wherein the contextual information for the WLAN associated with the MNO comprises at least one of a quality policy, a reputation, a location, an operator, a network type, or a cost.

18. The mobile device of claim 16, wherein the one or more first signal-related characteristics comprise at least one of a data throughput, a data latency, or a jitter metric of the connection with the WLAN.

19. The mobile device of claim 16, wherein the one or more first signal-related characteristics comprise a signal strength of the connection with the WLAN.

20. the mobile device of claim 16, wherein the determination of the first quality metric comprises comparing one or more types of the contextual information to a first threshold of the wireless network policy.

21. The mobile device of claim 20, wherein the instructions further implement the connection manager to obtain an indication of the first threshold from the wireless network policy.

22. The mobile device of claim 16, wherein determining the first quality metric comprises comparing one or more of the first signal-related characteristics to a second threshold of the wireless network policy.

23. A computer-readable storage medium comprising instructions which, when executed by one or more processors, cause the one or more processors to:
determine, based on a wireless network policy of a mobile device, contextual information for a wireless local area network (WLAN) connection available through an access point (AP) to a WLAN associated with a mobile network operator (MNO);
measure one or more first signal-related characteristics of the WLAN connection available through the AP;
determine, based on the contextual information and the first signal-related characteristics, a first quality metric for the WLAN connection available through the AP;
measure one or more second signal-related characteristics of a cellular network connection available through a base station to a cellular network associated with the MNO;
determine, based on the second signal-related characteristics, a second quality metric for the cellular network connection available through the base station;
compare the first quality metric to the second quality metric to produce a comparison result; and
connect, based on the comparison result, to either the WLAN through the AP or the cellular network through the base station.

24. The computer-readable storage medium of claim 23, wherein the contextual information for the WLAN associated with the MNO comprises at least one of a quality policy, a reputation, a location, an operator, a network type, or a cost.

25. The computer-readable storage medium of claim 23, wherein the one or more first signal-related characteristics comprise at least one of a data throughput, a data latency, or a jitter metric of the connection with the WLAN.

26. The computer-readable storage medium of claim 23, wherein the one or more first signal-related characteristics comprise a signal strength of the connection with the WLAN.
